(19) United States
(12) Patent Application Publication
(10) Pub. No.: US 2002/0131660 A1
(43) Pub. Date: Sep. 19, 2002

(54) Cardan shaft bearing

(76) Inventors: Karl-Heinz Bade, Waldmichelbach (DE); Michael Schutz, Schliengen (DE)

Correspondence Address: KENYON & KENYON, ONE BROADWAY, NEW YORK, NY, 10004, US

(21) Appl. No.: 10/097,150

(22) Filed: Mar. 12, 2002

(30) Foreign Application Priority Data
Mar. 14, 2001 (DE) 101 12 453.8

(51) Int. Cl. F16C 27/00

(52) U.S. Cl. 384/536

(57) ABSTRACT

A cardan shaft bearing which includes a roller bearing whose outer ring is connected to a bearing support which can be fixed to the vehicle body by an elastic element, the elastic element (16) including two rubber folds (2, 2′), attached to the outer ring (5) of the roller bearing (13), which form a circular cavity (14) in which a stop buffer (1) is positioned so that the roller bearing (13) can be elastically supported on carrier ring (3).

### BACKGROUND OF THE INVENTION

1. Field of the Invention

The invention relates to a cardan shaft bearing having a roller bearing, whose outer ring is connected by an elastic element to a bearing support which can be fixed to the vehicle body.

2. Description of Related Art

A layout of bearings is known from DE 197 48 726, in which a spring element made of elastomer connects the outer ring of a roller bearing with a ring-shaped, rigid housing part. The rubber element formed as a C-shape in cross section makes possible a suspension of the cardan shaft that is yielding in the radial and the axial direction. In DE 40 33 592, supporting the cardan shaft of a motor vehicle by an elastic shaft bearing with the aid of ring lips is proposed.

Up to a certain borderline amplitude, these known bearing systems can absorb vibrations of the shaft bearing, and prevent their transmission to the body of the motor vehicle. However, in the resonance case, the borderline amplitude can be exceeded. The result is impact noises, which can propagate themselves into the passenger compartment, even when the impact surfaces are coated with rubber. Passenger comfort is then considerably impaired.

This problem is solved in DE 43 17 062 by a hydraulically damping cardan shaft bearing, that keeps the disturbing excitation of vibrations away from the passenger compartment, even in the resonance range. Extreme deflections of the bearing are absorbed by a ring-shaped cavity filled with liquid. However, manufacturing this hydraulically damping cardan shaft bearing is comparatively costly.

### SUMMARY OF THE INVENTION

It is an object of the invention to provide a cardan shaft bearing, which is so yielding in the radial and the axial direction, wherein vibrations of the cardan shaft in the entire operating range are largely decoupled from the body of the motor vehicle. With all that, manufacturing should be simple and possible to do at low cost.

These and other objects of the invention are achieved by a cardan shaft bearing comprising a roller bearing whose outer ring is connected by an elastic element to a carrier ring which can be fixed to the vehicle body, wherein the elastic element (16) includes two rubber folds (2, 2′), attached to the outer ring (5) of the roller bearing (13), which form a circular cavity (14) in which a stop buffer (1) is positioned so that the roller bearing (13) can be elastically supported on carrier ring (3).

### BRIEF DESCRIPTION OF THE DRAWINGS

The present invention will be described in greater detail with reference to the following drawings wherein:

FIG. 1 shows a preferred exemplary embodiment of the cardan shaft bearing according to the present invention in a cross sectional representation.

FIG. 2 shows a side view of FIG. 1.

FIG. 3 shows a partial section of FIG. 1 in an enlarged representation, in the region of the sections of the rubber folds lying radially on the outside.

### DETAILED DESCRIPTION OF THE INVENTION

The invention provides an elastic element which includes two rubber folds, attached to the outer ring of the roller bearing, which form a circular cavity, in which a stop buffer is positioned in such a way that the roller bearing can be elastically supported on the bearing support. Because of the elastic support of the roller bearing on the bearing support, there is no impact contact, and there are thus no impact noises. The elastic impact buffer and the soft elastic rubber folds absorb the vibrational load in a damping way, and insulate it to a great extent from the body of the motor vehicle, over the entire operating range. The stop buffer rotating in the cavity is sealed off from disturbing influences in the surroundings by the rubber folds integrally formed with the outer ring of the roller bearing. Because of that, the material for the stop buffer can be designed optimally with regard to damping and insulating effectiveness. It is possible to use porous material.

Advantageously, in the region of the attachment, the elastic element has a rubber crosspiece connecting the rubber folds and forms a one-piece vulcanization part, which is vulcanized onto the outer circumferential surface of the outer ring. This rubber-metal connection is long-lived and is technically simple to produce. During its production, the single-piece vulcanization part has the shape of a U profile opened radially outward, and can be made cost-effectively by an injection molding technique. The rubber part can be conventionally released from the mold. The vulcanizing tool is constructed in a correspondingly simple fashion.

A particularly good vibration insulation is achieved if the stop buffer is under radial prestressing between the outer ring and the supporting carrier ring, during normal use. The damping performance characteristics can then be predefined progressively.

In this connection, it is preferred if the stop buffer is formed from an open-pored plastic material. Thanks to the protective rubber sheathing, even less resistant materials with respect to the rough environmental conditions can be applied. Especially suitable for the damping and the insulation of vibration is a stop buffer made of open-cell polyurethane foam. Using this material, the rotational and bending vibrations of the cardan shaft can be insulated especially effectively from the body, and the elastic cardan shaft bearing can be manufactured cost-effectively.

It is of advantage if each rubber fold respectively can be supported on the carrier ring by a supporting ring vulcanized in on a section lying radially outside. The vulcanized-in sheet metal ring forms a reinforcement and makes possible a stable fixing of the soft elastic air bellows in the carrier ring.

A hollow cross section of the air bellows is preferred, in which the rubber folds are formed essentially C-shaped and axially respectively open in the direction of the opposite fold. Because of that, the elastic element can follow extreme deflection movements in both the radial and the axial direction in highly flexible fashion. The C-shaped cross sectional geometry of the folds avoids an inadmissibly high material stress on the rubber folds, which is favorable for the service life. As explained above, the vulcanization part, during the production of the air bellows, has an essentially U-shaped profile opening radially outwards. Its lateral sides, during the mounting stage of the cardan shaft bearing, form the convexly bent rubber folds of the air bellows. Air bellows and stop buffer act, from a technically functioning point of view, in parallel connection. The damping and insulating performance of the elastic element can thus be predefined over a wide range by a suitable selection of the material and the cross sectional geometry of the stop buffer and by the wall thickness of the rubber folds.

It is advantageous if the sections of the integrally formed rubber folds lying radially on the outside, during normal use, are positioned axially adjacent inside the carrier ring, or separated from one another by an intermediate ring. During the mounting stage of the cardan shaft bearing, the axial separation distance of the rubber folds, and thereby the curvature of the folds of the ring bellows can be predefined.

In mass production, fastening the rubber folds in the carrier ring is advantageously accomplished by flanges which form a retaining clamp for the sections of rubber folds lying radially on the outside. In this connection it is preferred if the flanges are arranged at end faces of the carrier ring, offset in the circumferential direction. Flanging and pressing in take place in one work step.

Since the cardan shaft bearing is usually positioned in a tunnel-like passage directly near the exhaust gas equipment, it is of advantage if the carrier ring, on its outer circumference, is fastened to the body by a heat shield. The heat shield reduces the effect of heat on the elastic parts, and thereby ensures good utilization properties over a long lifetime. For manufacturing it is advantageous if the heat shield is made as a sheet metal ring, and peripheral beads hold the carrier ring.

It is also recommended that the elastic element have a shoulder which is moved up radially inwards in each case, on one end face of the outer ring of the roller bearing. During a wobble motion of the cardan shaft, this collar is suitable for absorbing axially directed deflection movements by form/positive locking, and thereby unloads the adhesion connection of the rubber-metal bond.

In order to achieve particularly good adhesion between rubber and metal, it has proven worthwhile to structure the outer circumference surface of the roller bearing's outer ring. This can advantageously be done by chemical, electrochemical or by mechanical surface treatment methods.

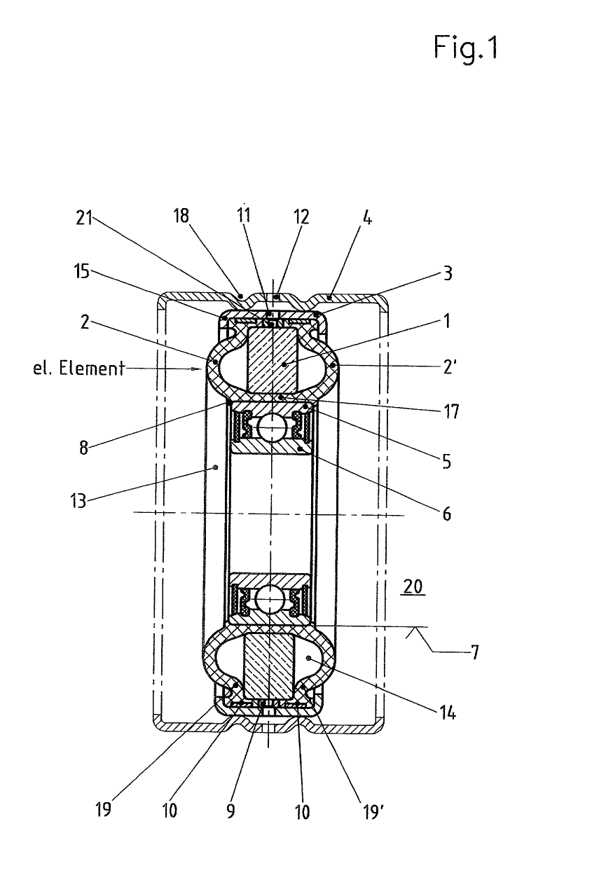

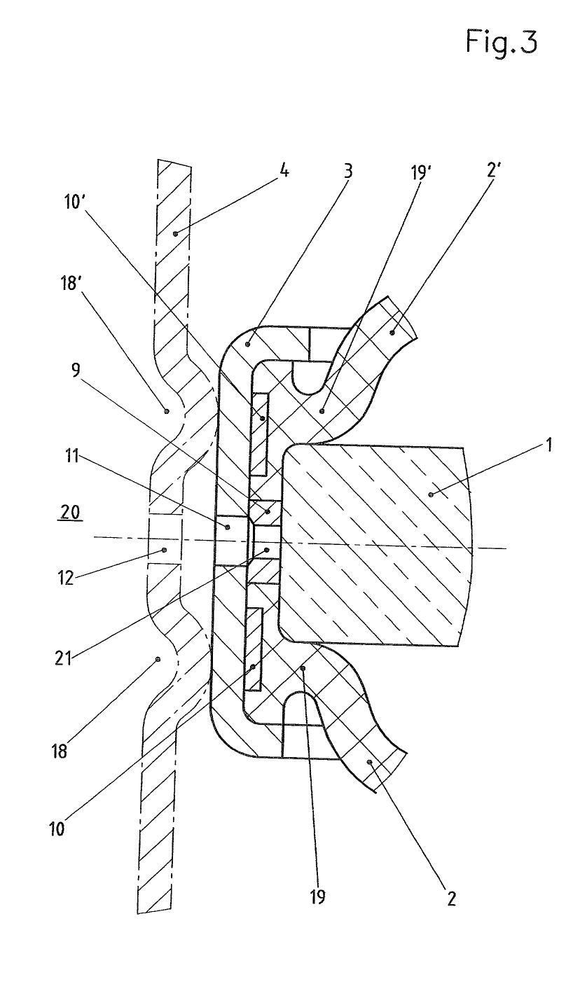

FIG. 1 shoes an exemplary embodiment of the present invention which can be used in applications such as in motor vehicles. A rubber part is vulcanized onto outer ring 5 of a grooved ball bearing 13, which is formed from two rubber folds 2, 2′ and a rubber crosspiece 17. The rubber folds 2, 2′, the rubber crosspiece 17 and the possibly present intermediate ring 9 enclose a ring-shaped cavity 14, in whose middle region there is a stop buffer 1. Sections 19, 19′ (FIG. 3), lying radially on the outside, of rubber folds 2 or 2′ and the possibly present intermediate ring 9 are held together by flanges 15. Carrier ring 3 forms a clamp carrier for sections 19, 19′. Stop buffer 1, together with rubber folds 2, 2′, form an elastic element 16 which elastically supports roller bearing 13 in carrier ring 3. As can be easily recognized in the drawing in FIG. 1, cavity 14 encloses stop buffer 1 similarly to a rubber jacket, and cuts it off from disturbing environmental influences. In cross section, rubber folds 2, 2′ are designed C-shaped. Each C-shaped rubber fold is formed open in the direction of the opposite fold, respectively. Thereby a circular bellows is formed.

In the illustrated exemplary embodiment of FIG. 1, stop buffer 1 is shown as an elastically deformable ring body having a rectangular cross section. Other cross sectional shapes are conceivable. According to the present invention, vibrations which are transmitted via inner ring 6, roller elements and outer ring 5 of bearing 13 to elastic element 16 are essentially damped from stop buffer 1 and insulated from the body of the motor vehicle.

Depending on the material and the radial stress of stop buffer 1, extending in the ring gap between outer ring 5 and carrier ring 3, the damping and the insulating characteristics can be determined over a broad working range. If the stop buffer is positioned already under stress in the ring gap, a progressive damping action is set. Even in the case of extreme deflection motions no impact noises are created. The elastic behavior of rubber folds 2, 2′ is a function of the wall thickness, the shape and the material used. Rubber folds 2, 2′ act in a parallel connection to stop buffer 1, from a technically functioning point of view. Excessive deformation of rubber folds 2, 2′ is avoided by their C-shaped formation. The elastic support favors long lasting use of the cardan shaft bearing.

For the purpose of venting cavity 14, openings 21, 11, 12 are provided in intermediate ring 9, in carrier ring 3 and in heat shield 4. In FIG. 1 these openings are drawn in as holes which connect space 14, surrounded by the rubber jacket, to the surroundings 20 in flow-conducting fashion. In end region 19, 19′ of rubber folds 2, 2′ lying radially on the outside, supporting rings 10, 10′ respectively are vulcanized in. These form a reinforcement in the elastomer, and facilitate fastening in carrier ring 3.

Usually the cardan shaft bearing in motor vehicles is positioned in the cardan shaft tunnel, through which the connecting pipes of the exhaust gas equipment of the motor vehicle also run. In order to avoid an inadmissible heating of the cardan shaft bearing, it can be advantageous to protect the bearing support from heating effects by a heat shield. Such a heat shield 4 is represented in FIG. 1 by broken lines. In the exemplary embodiment shown, carrier ring 3 is held in heat shield 4 by beads 18, 18′. Heat shield 4 is fastened to the body, which is not shown in FIG. 1.

With regard to economical manufacturing of the cardan shaft bearing, it is of advantage if the elastic element is fastened directly to outer ring 5 of roller bearing 13. In the illustrated preferred specific embodiment, elastic element 16 is formed as a vulcanization part which is vulcanized directly to the outer surface 7 of outer ring 5. Very good adhesion between rubber and metal can be achieved by roughening metallic outer circumferential surface 7 of the bearing by chemical, electrochemical or mechanical surface treatment methods.

Furthermore, in FIG. 1 elastic element 16 is provided with a collar 8, which is moved up radially inwards in each case at one end face of roller bearing 13. In this fashion one achieves a very durable rubber-metal connection, which withstands over a long service life even frequently recurring, extreme deflections and wobble motions of bearing 13.

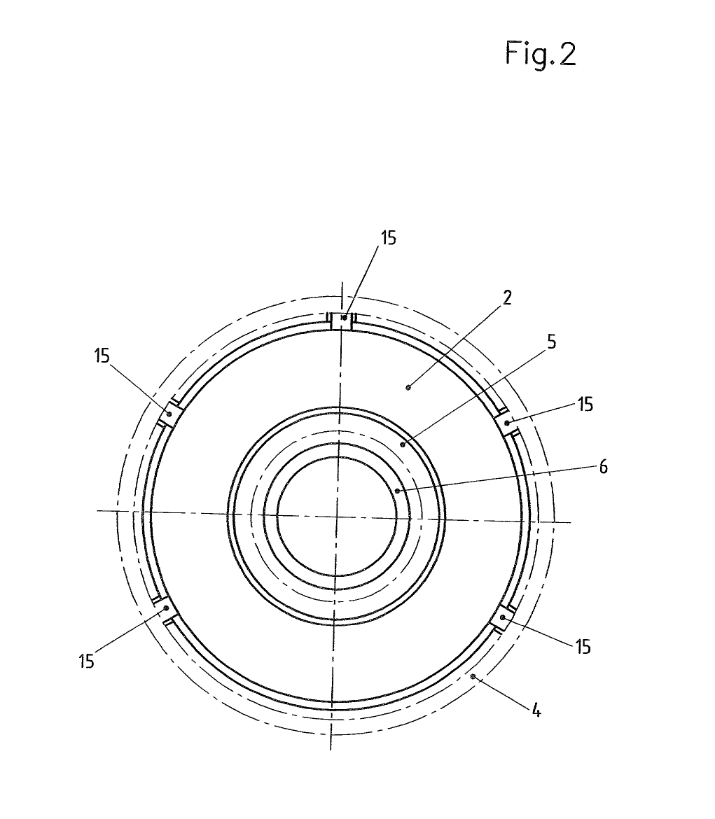

The drawings of FIGS. 1 through 3 each show the mounting stage of the cardan shaft bearing according to the present invention. However, during manufacturing, the radial end sections 19, 19′ do not lie side by side but have acquired, as was explained above, the shape of a U-profile in the vulcanization tool. The lateral sides of the U-profile, which, in normal use, are curved to bellows folds 2, 2′, are connected by rubber crosspiece 17. This geometry is favorable for mass production, since the vulcanization tool is constructed simply, and the elastomer part can conventionally be easily unmolded. As shown in FIG. 3 in an enlarged illustration, radial end sections 19, 19′ of the two rubber folds 2, 2′ are fastened to each other by flange 15 of carrier ring 3. In each of the end sections 19 or 19′ a reinforcement 10 or 10′ in the form of a sheet metal ring is vulcanized in. In this way the bellows can be stably fixed to carrier ring 3, possibly in connection with intermediate ring 9. The sectional drawing shows that carrier ring 3 holds together radial sections 19, 19′, similarly to a retaining clamp. Holes 11, 12 and 21 are there, as mentioned above, for venting cavity 14.

A broad spectrum of elastic materials can be used for stop buffer 1. Because of the protective rubber jacket, formed by folds 2, 2′ and carrier ring 3, stop buffer 1 is protected in an excellent way from external influences, such as contaminations in the form of dampness and/or dust. This is favorable during aging of the buffer material, and means that, in selecting the damping material for stop buffer 1, no consideration has to be taken of the environment. The buffer material can optimally be adapted to the respective givens of the particular application. One skilled in the art, therefore, has available a broad spectrum of usable elastic materials, all the way up to open cell foam material. Microcell polyurethane has proven to be especially advantageous as the material. Obviously, the stop buffer can also be made of several ring layers of the same or different materials, which may, for example bring forth a progressive damping characteristic.

Rubber folds 2, 2′ can be embodied comparatively thin-walled, and made of a material having low Shore hardness. There is then little deformation work in the elastomer, which is favorable for the service life of the folds.

Fixing stop buffer 1 to rubber crosspiece 17 or to outer circumference surface 7 of outer ring 5 can be done, for example, by vulcanizing it on or by adhesion.

What is claimed is:

1. A cardan shaft bearing, comprising a roller bearing whose outer ring is connected by an elastic element to a carrier ring which can be fixed to a vehicle body, wherein the elastic element (16) includes two rubber folds (2, 2′), attached to the outer ring (5) of the roller bearing (13), which form a circular cavity (14) in which a stop buffer (1) is positioned so that the roller bearing (13) can be elastically supported on carrier ring (3).

2. The cardan shaft bearing according to claim 1, wherein the elastic element (16) has a rubber crosspiece (17) connecting the rubber folds (2, 2′) in the vicinity of the attachment, so as to form a one-piece vulcanization part, which is vulcanized on at an outer circumferential surface (7) of the outer ring (5).

3. The cardan shaft bearing according to claim 1, wherein the stop buffer (1), during normal use, is under radial prestressing between the outer ring (5) and the supporting carrier ring (3).

4. The cardan shaft bearing according to claim 2, wherein the stop buffer (1), during normal use, is under radial prestressing between the outer ring (5) and the supporting carrier ring (3).

5. The cardan shaft bearing according to claim 1, wherein the stop buffer (1) is formed from an open-pore plastic made of open-cell PU foam.

6. The cardan shaft bearing according to claim 1, wherein each rubber fold (2, 2′) is supportable on the carrier ring (3) by a support ring (10, 10′), respectively, vulcanized into a section (19, 19′) lying radially on the outside.

7. The cardan shaft bearing according to claim 2, wherein each rubber fold (2, 2′) is supportable on the carrier ring (3) by a support ring (10, 10′), respectively, vulcanized into a section (19, 19′) lying radially on the outside.

8. The cardan shaft bearing according to claim 6, wherein the sections (19, 19′), during normal use, are positioned axially adjacent, or separated by an intermediate ring (9), in the carrier ring (3).

9. The cardan shaft bearing according to claim 1, wherein the rubber folds (2, 2′) are designed essentially C-shaped, in each case axially open in the direction of the opposite fold.

10. The cardan shaft bearing according to claim 2, wherein the rubber folds (2, 2′) are designed essentially C-shaped, in each case axially open in the direction of the opposite fold.

11. The cardan shaft bearing according to claim 6, wherein the carrier ring (3) has flanges (15) which form a retaining clamp for the sections (19, 19′) lying radially on the outside.

12. The cardan shaft bearing according to claim 8, wherein the carrier ring (3) has flanges (15) which form a retaining clamp for the sections (19, 19′) lying radially on the outside.

13. The cardan shaft bearing according to claim 11, wherein the flanges (15) are positioned at the end faces fo the carrier ring (3), offset as viewed in a circumferential direction the carrier ring.

14. The cardan shaft bearing according to claim 1, wherein the carrier ring (3) is fixed to the vehicle body on an outer peripheral side by a heat shield (4).

15. The cardan shaft bearing according to claim 2, wherein the carrier ring (3) is fixed to the vehicle body on an outer peripheral side by a heat shield (4).

16. The cardan shaft bearing according to claim 14, wherein the heat shield (4) is made as a sheet metal ring, and circumferential beads (18, 18′) hold the carrier ring (3).

17. The cardan shaft bearing according to claim 1, wherein the elastic element (16) has a shoulder (8) which is moved up radially inwards, in each case, at one end face of the roller bearing (13).

18. The cardan shaft bearing according to claim 1, wherein to vent the cavity (14), openings (11; 12; 21) are provided which connect the cavity to surroundings (20) in a flow-conductive manner.

19. The cardan shaft bearing according to claim 2, wherein to vent the cavity (14), openings (11; 12; 21) are provided which connect the cavity to surroundings (20) in a flow-conductive manner.

20. The cardan shaft bearing according to claim 1, wherein an outer peripheral surface (7) of the outer ring (5) is structured electrochemically.
